(19) United States
(12) Patent Application Publication
(10) Pub. No.: US 2005/0206974 A1
(43) Pub. Date: Sep. 22, 2005

(54) Image reading apparatus

(75) Inventors: Yusuke Hashizume, Urayasu-shi (JP); Sueo Ueno, Mishima-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/805,316

(22) Filed: Mar. 22, 2004

(51) Int. Cl. H04N 1/04

(52) U.S. Cl. 358/505; 358/483

(57) ABSTRACT

An image reading apparatus for reading a document image to provide image data corresponding thereto, including a photoelectric conversion unit which converts a light-received image into an image signal, a photoelectric conversion unit which converts an optical image on a document into an image signal, an image processing unit which processes the image signal outputted from the photoelectric conversion unit, and provides the image data, a power source unit which supplies power to respective units including the photoelectric conversion units and the image processing unit of the image reading apparatus, and a power supply control unit which controls power supply from the power source unit to the photoelectric conversion unit.

### BACKGROUND OF THE INVENTION

The present invention is applied to an image reading apparatus such as a document scanner, and an image forming apparatus such as a copying machine, and relates to a method for supplying power to a CCD (Charge Coupled Device) for converting an optical image into an electric signal.

Generally, a scanner that reads a document image has a first carriage having a light source and a first mirror, a second carriage having second and third mirrors, a lens and a CCD, etc. When a document is read by the scanner, the document placed on a document glass plate is illuminated by the light source of the first carriage that moves in the sub-scanning direction. Reflected light from the document is reflected on the first to third mirrors, and is concentrated by the lens and guided to the CCD sensor. At that time, the second carriage moves such that an optical path length of the reflected light from the document to the CCD is constant, in a direction which is the same as the moving direction of the first carriage and at a half-speed of that of the first carriage. The CCD sensor scans the incident reflected light in the main scanning direction. As a result, a document image of one scanning line is converted into an electric signal. By scanning the document in the sub-scanning direction by using the first and second carriages, image data corresponding to the entire range of the document image is provided from the CCD sensor.

In, for example, an image forming apparatus provided with a scanner, when the apparatus is not used for a long time, or a power saving mode switch is pressed, the apparatus is generally set in a power saving mode. In the power saving mode, power supplied to respective units of the apparatus is partially shut off. As the power saving mode, there is a method in which power supply to a main portion of a printer unit is shut off, or a method in which power supply to the main portion of the printer unit and a scanner is shut off.

In the method in which power to a scanner is shut off, an initial operation of the scanner must be carried out after returning from the power saving mode, and it takes long time for warming-up. Further, in the method in which the power source of the scanner is not shut off during the time of power saving mode, power is always supplied even when the scanner is not used, which wastes electric power and shortens the lifetime of a CCD.

### SUMMARY OF THE INVENTION

An object of the present invention is to shorten a warming-up time of a scanner at the time of returning from a power saving mode, and to realize lengthening of the lifetime of a CCD.

In order to achieve the above object, according to one aspect of the present invention, there is provided an image reading apparatus for reading a document image to provide image data corresponding thereto, comprising: a photoelectric conversion unit which converts an light-received image into an image signal; an image providing unit which optically reduces the document image to provide the image to photoelectric conversion unit; an image processing unit which processes the image signal outputted from the photoelectric conversion unit, and provides the image data; a power source unit which supplies power to respective units including the photoelectric conversion units and the image processing unit of the image reading apparatus; and a power supply control unit which controls power supply from the power source unit to the photoelectric conversion unit.

### BRIEF DESCRIPTION OF THE DRAWINGS

FIG. 1 is a block diagram schematically illustrating a configuration of an image forming apparatus to which the present invention is applied.

FIG. 2 is a cross sectional view illustrating a structure of a scanner unit according to the present invention using a CCD.

FIG. 3 is a block diagram illustrating an electrical configuration of the scanner unit.

FIG. 4 is a diagram illustrating a configuration example of a CCD power source control unit 305.

FIG. 5 is a diagram illustrating another configuration example of the CCD power source control unit 305.

FIG. 6 is a diagram illustrating even other configuration example of the CCD power source control unit 305.

FIG. 7 is a flowchart showing a mode transition of the image forming apparatus.

FIG. 8 is a flowchart showing operations at the time of a power saving mode according to the present invention.

FIG. 9 is a block diagram illustrating of a configuration of an image reading apparatus 350.

### DETAILED DESCRIPTION OF THE EMBODIMENTS

An embodiment of the present invention will be described in detail hereinafter with reference to the drawings.

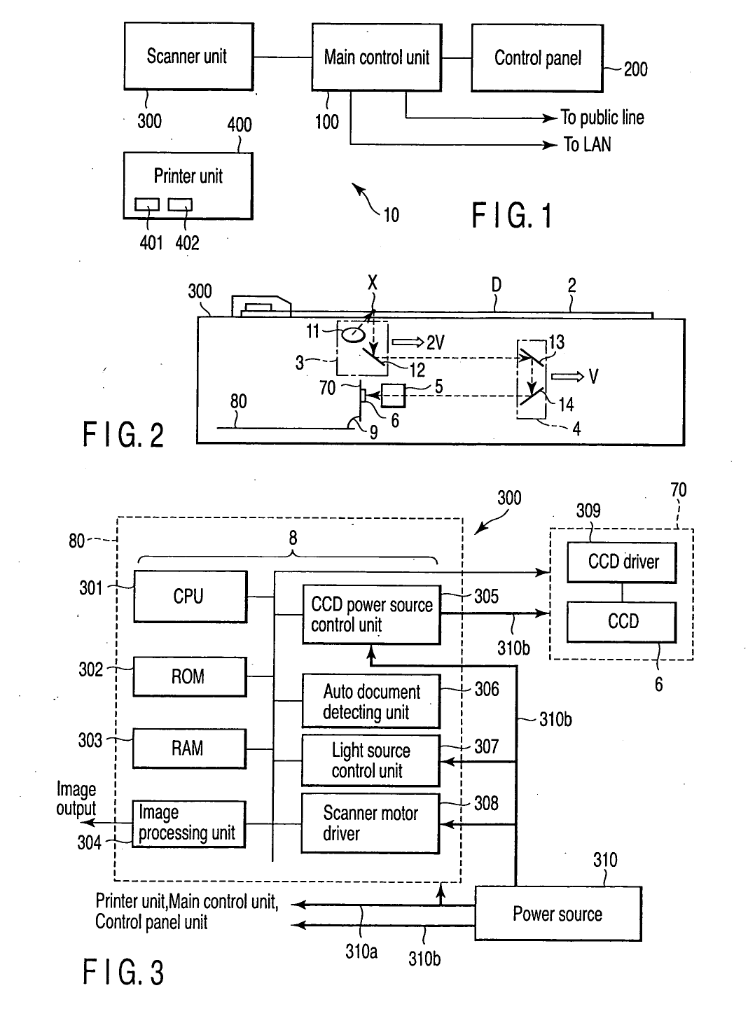

FIG. 1 is a block diagram schematically illustrating a configuration of an image forming apparatus 10 such as a digital copying machine to which the present invention is applied. The image forming apparatus 10 includes a scanner unit 300 which reads a document image to provide image data corresponding to the document image, a printer unit 400 which forms an image onto a paper sheet on the basis of the image data from the scanner unit 300, a control panel unit 200 which acts as a user interface, and a main control unit 100 which performs overall control of the respective units of the image forming apparatus 10 on the basis of a user instruction inputted via the control panel unit 200.

The main control unit 100 can facsimile image data on the document read by the scanner unit 300, via a public line such as a telephone line or the like, and the image data received by facsimile via the public line can be printed by the printer unit 400. The main control unit 100 can also receive text data from an external device such as a personal computer or the like via a network such as a LAN, and can print it by the printer unit 400.

FIG. 2 illustrates a structure of the scanner unit (reading apparatus) 300 using a CCD 6 according to the present invention. The scanner unit 300 reads image information on the document at intervals of scanning lines corresponding to a resolution.

A document D is placed such that the image surface side thereof is made to direct downward on a document platen 2. When a start button (not shown) is pressed down, a light source 11 using a xenon light source, a cold-cathode tube, a halogen lamp, or the like is turned on, and the irradiation light at that time permeates through the document platen 2, and is irradiated onto a reading position X of the document D.

A first carriage 3 including the light source 11 and a first mirror 12, and a second carriage 4 including a second mirror 13 and a third mirror 14 are moved in the directions of the arrows in the drawing by a driving system composed of an unillustrated driving motor, and belt or wire, etc. In accordance therewith, the reading position X moves from the left to the right in the drawing, and the document D is scanned in the sub-scanning direction. At that time, the moving speed of the first carriage 3 is double that of the second carriage 4. Accordingly, an optical path length (a focal length) from the document D to the light-receiving surface of the CCD is maintained to be constant. The first carriage 3, the second carriage 4, and a lens 5 serve as an image providing unit which provides a reduced document image to the CCD 6.

The CCD 6 is a photoelectric conversion device for converting an optical image into an electric signal. Namely, the CCD 6 scans incident reflected light in the main scanning direction, and converts an image of one scanning line on a document image surface into an electric signal. In the present embodiment, a case will be described in which a CCD is used as a photoelectric conversion device. However, as a photoelectric conversion device, a C-MOS sensor or the like can be used.

In addition to the aforementioned CCD 6, a CCD driver for driving the CCD 6 is packed on a CCD substrate 70. On a processing substrate 80, an image processing unit for processing the image signal outputted from the CCD 6 and a scanner control unit (which will be described later) including a control unit which controls overall the scanner unit 300 are mounted. The CCD substrate 70 and the processing substrate 80 are connected by a harness 9.

FIG. 3 is a block diagram illustrating an electrical configuration of the scanner unit 300.

A scanner control unit 8 is mounted on the above-described processing substrate 80, and includes a scanner CPU (Central processing Unit) 301, a ROM 302, a RAM 303, a scanner motor driver 308, an image processing unit 304, a light source control unit 307 which controls a light source 12, an auto document detecting unit 306, and a CCD power source control unit 305.

The scanner CPU 301 performs overall control of the scanner unit 300 in accordance with a control program stored in the ROM 302, and uses the RAM 303 for temporarily storing data. The scanner motor driver 308 controls the rotation speed of a driving motor that moves the first and second carriages 3 and 4, or the like. The auto document detecting unit 306 detects whether the document is placed on the document platen 2, or whether the placed document is a color document or a monochrome document, and a size of the document, or the like.

The image processing unit 304 includes an A/D conversion circuit for converting an analog signal from the CCD 6 into a digital signal, a shading correction circuit for correcting fluctuations in a threshold level with respect to an output signal from the CCD 6 due to an ambient temperature change or the like, and a gamma correction circuit. Further, the image processing unit 304 includes a line memory for temporarily storing the corrected digital signal from these correction circuits. Moreover, the image processing unit 304 carries out image processings, such as trimming, masking, enlargement/reduction processing, resolution conversion processing, compression/incompression processing on images, and the like, with respect to the corrected image data.

A power source 310 supplies a power supply voltage of, for example, +5 V, to a signal processing circuit such as the CPU 301 and the ROM 302 via a power source line 310a, and supplies a power supply voltage of, for example, +12 V, to a driving unit such as the scanner driver 308 via a power source line 310b.

A CCD driver 309 drives the CCD 6 by transmitting various CCD control signals to the CCD 6. The CCD power source control unit 305 turns power supply from the power source 310 to the CCD substrate 70 (the CCD driver 7 and the CCD 6) on/off.

Next, a method for controlling power supply to the CCD according to the present invention will be described.

In a state where the power source of the apparatus is turned on, when the apparatus is not used for a long time, or a power saving mode switch is pressed down, the apparatus is set in the power saving mode, and power supply to the respective units of the apparatus is partially shut off. At that time, in the present embodiment, power supply to the CCD as well is shut off. At the time of the power saving mode, the main control unit 100 transmits an instruction to the scanner CPU 301 to turn the CCD power source off. In accordance with this instruction, the scanner CPU 301 turns off power supply from the power source 310 to the CCD substrate 70 (the CCD 6 and the CCD driver 309) by the CCD power source control unit 305.

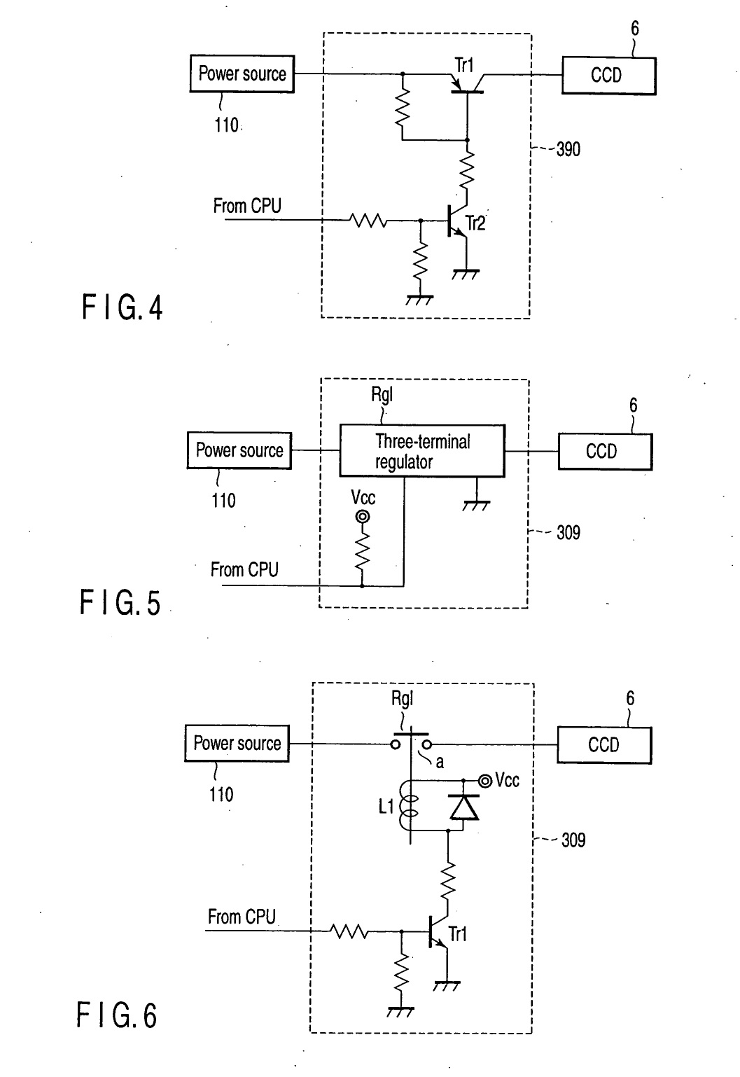

FIGS. 4 to 6 are diagrams respectively illustrating configuration examples of the CCD power source control unit 305. FIG. 4 is a configuration in which the power is shut off by a transistor circuit. At the time of current-applying, a current-applying active signal is outputted from the scanner CPU 301, and a transistor Tr2 is turned on. In accordance therewith, a transistor Tr1 arranged between the power source 310 and the CCD is turned on, and power is supplied from the power source 310 to the CCD. During the time of shutting-off the power source, the output of the current-applying active signal from the scanner CPU 301 is stopped, and the transistor Tr2 is turned off. Accordingly, the transistor Tr1 arranged between the power source 310 and the CCD is turned off, and the power supply from the power source 310 to the CCD is stopped.

FIG. 5 is a configuration in which a function of turning the output off of a three-terminal regulator is used. At the time of current-applying, a current-applying active signal is outputted from the scanner CPU 301, the output of a three-terminal regulator Rgl is turned on, and power is supplied to the CCD. During the time of shutting off power source, the output of the current-applying active signal from the scanner CPU 301 is stopped, the three-terminal regulator Rgl is turned off, and the power supply from the power source 310 to the CCD is stopped.

FIG. 6 is a configuration in which the power is shut off by a mechanical contact circuit. At the time of current-applying, a current-applying active signal is outputted from the scanner CPU 301, and a transistor Tr3 is turned on. In accordance therewith, electric current is applied to a driving coil L1 of a relay Re1 arranged between the power source and the CCD, and the driving coil L1 is excited, so that a relay contact a is turned on, and power is supplied from the power source to the CCD. During the time of shutting off the power, the current-applying active signal from the scanner control substrate is stopped, and the transistor Tr3 is turned off. Accordingly, the current flowing in the driving coil L1 of the relay Re1 arranged between the power source and the CCD is stopped, and the excitation is stopped. As a result, the relay contact a is turned off, and the power supply from the power source to the CCD is stopped.

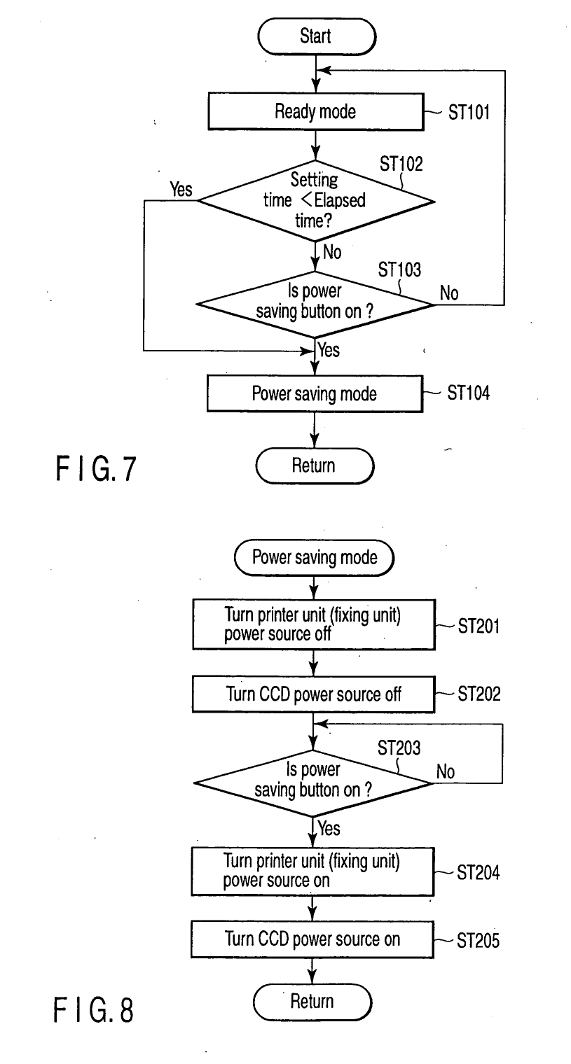

FIG. 7 is a flowchart showing a mode transition according to the present invention.

After the power source of the image forming apparatus is turned on and the respective units of the apparatus are initialized, or after a copying operation is completed, the main control unit 100 sets the image forming apparatus to being in a ready mode (ST101). In the ready mode, the main control unit 100 determines, for example, whether or not there is an instruction input from a user via the control panel unit 200, and when there is an instruction input, the main control unit 100 carries out processing corresponding to the inputted instruction.

In the ready mode, the main control unit 100 determines whether or not an elapsed time from the time when the apparatus is set in the ready mode up to now passed over a setting time relating to the power saving mode (for example, about several ten minutes) (ST102). When the elapsed time has exceeded the setting time, the main control unit 100 sets the image forming apparatus to being in the power saving mode (ST104). When the elapsed time is not over the setting time, the main control unit 100 determines whether or not a power saving button (not shown) provided at the control panel unit 200 has been pressed by the user (ST103). When the power saving button has been pressed, the main control unit 100 sets the image forming apparatus to being in the power saving mode (ST104).

FIG. 8 is a flowchart showing operations at the time of a power saving mode.

In the power saving mode, the main control unit 100 stops part or all of the power supply to the printer unit 400. When the power supply to the printer unit 400 is partially stopped, the main control unit 100 stops, for example, the power supply to a fixing device 401 by using a power source control unit 402. The configuration of the power source control unit 402 is the same as that of the power source control unit 305 shown in FIGS. 4 and 5. The fixing device 401 is a device in which a toner image transferred on a paper sheet is fixed on the paper by heat and pressure of a heat roller (not shown). Because an electric power consumption of the fixing device at the time of stand-by is relatively large, the main control unit 100 stops the power supply to the fixing device 401 in the ready mode.

Next, the main control unit 100 instructs the scanner CPU 301 to stop power supply to the photoelectric conversion unit of the scanner unit 300. The scanner CPU 301 stops power supply to the CCD substrate 70 by using the CCD power source control unit 305. Note that, in such a power saving mode, the power supply to only the CCD 6 may be stopped.

After the CCD power is shut off as in step ST202, the main control unit 100 determines whether or not a power saving button of the control panel unit 200 is pressed (ST203). When the power saving button is pressed, the main control unit 100 starts the power supply to the printer unit 400 (the fixing device 401) and the CCD substrate 70 (the CCD driver 309 and the CCD 6) again (ST204, ST205), and cancels the power saving mode.

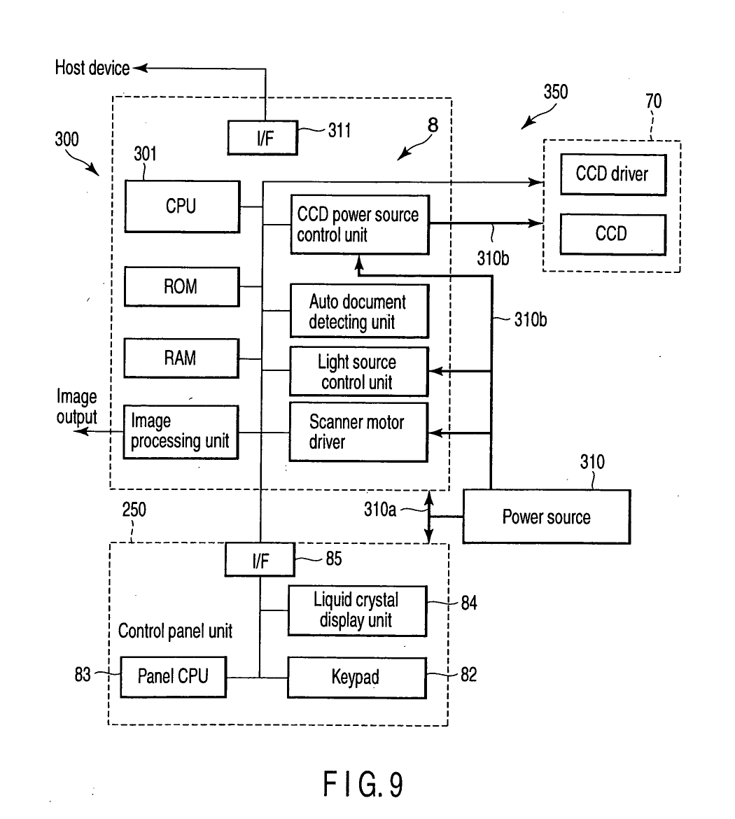

There is described above the case where the present invention is applied to a copying machine. However, it goes without saying that the present invention can be applied to an image reading apparatus (scanner) as well. FIG. 9 is a block diagram illustrating a configuration of an image reading apparatus 350. Components which are the same as those of the scanner control unit 300 shown in FIG. 3 are denoted by the same reference numerals, and detailed descriptions thereof will be omitted.

The image reading apparatus 350 is composed of the scanner unit 300 of FIG. 3 and a control panel unit 250. The control panel unit 250 includes a keypad 82, a panel CPU 83, a liquid crystal display unit 84, and a control panel I/F 85. The panel CPU 83 carries out communication with the CPU 301 via the control panel I/F 85. A screen for setting document reading conditions, or the like is displayed on the liquid crystal display unit 84, and the panel CPU 83 receives the data relating to the document reading conditions keyboarded from the user via the keypad 82, and transmits the keyboarded data to the scanner control unit 8 and displays it on the liquid crystal display unit 84.

The image reading apparatus 350 is connected to a host device such as a personal computer or the like via an interface 311. The image reading apparatus 350 reads a document in accordance with an instruction from the host device, and can transmit the document image data to the host device.

As shown in FIGS. 7 and 8, the image reading apparatus 350 stops the power supply to the CCD 6 or the CCD substrate 70 during a power saving mode. When the host device such as a personal computer or the like has a power saving mode, there may be configured such that the image reading apparatus 350 is set in a power saving mode during the time when the host device is being in a power saving mode. In that case, the image reading apparatus 350 automatically detects the power saving mode of the host device, or notifies the image reading apparatus 350 of the power saving mode from the host device, and therefore, the image reading apparatus 350 is set in the power saving mode.

As described in detail above, in accordance with the present invention, the power supply to the photoelectric conversion unit (CCD) is selectively stopped during the time of a power saving mode. Accordingly, as compared with the case where the power supply to the scanner unit is totally stopped during the time of a power saving mode as in the prior art, a warming-up time of the scanner unit 300 when the power supply is returned can be shortened. Moreover, according to the present invention, because an attempt can be made to lengthen the lifetime of a CCD, an image forming apparatus or an image reading apparatus which has a high reliability can be provided.

For example, at convenience stores, a current-applying time of an image forming apparatus or an MFP in which a FAX stand-by function is always being set to ON is twenty-four hours per day throughout the year. Provided that it is calculate from the fact that a lifetime of a CCD is generally 22,000 hours, an exchange of the CCD arises every two and a half years (=(22,000 hours/24 hours)/365 days). If a power saving mode of twelve hours arises per one day, a time for exchange is five years (=(22,000 hours/12 hours)/365 days) in accordance with the present invention, so that the lifetime of the CCD and the lifetime of the MFP are the same, and there is no need to exchange the CCD. Further, the maintenance work accompanying this exchanging is unnecessary.

Further, in accordance with the present invention, it is possible to individually turn the power supply to the photoelectric conversion unit on/off. Accordingly, when the image forming apparatus is used as a so-called network printer for carrying out printing on the basis of image data received via a LAN, the power supply to the photoelectric conversion unit may be stopped.

The above description is the embodiments of the present invention, and the apparatus and the method of the present invention are not limited thereto, and various modified examples can be implemented. Such modified examples are included in the present invention. Further, apparatuses or methods which are configured by appropriately combining the components, the functions, the features, or the steps of the method in the respective embodiments are included in the present invention.

1. An image reading apparatus for reading a document image to provide image data corresponding thereto, comprising:
a photoelectric conversion unit which converts an optical image on a document into an electric image signal;
an image processing unit which processes the image signal outputted from the photoelectric conversion unit, and provides the image data;
a power source unit which supplies power to respective units including the photoelectric conversion unit and the image processing unit of the image reading apparatus; and
a power supply control unit which controls power supply from the power source unit to the photoelectric conversion unit.

2. An image reading apparatus according to claim 1, wherein, when the image reading apparatus is not used for a predetermined time, the power supply control unit stops power supply to the photoelectric conversion unit.

3. An image reading apparatus according to claim 1, wherein the power supply control unit comprises one of a semiconductor switch, a relay, and a three-terminal regulator.

4. An image reading apparatus according to claim 1, further comprising an interface to carry out communication with an external device, wherein the power supply control unit stops power supply to the photoelectric conversion unit in accordance with an instruction of a power saving mode received via the interface.

5. An image reading apparatus according to claim 1, wherein the photoelectric conversion unit comprises a CCD (Charge Coupled Device).

6. An image reading apparatus according to claim 1, wherein the photoelectric conversion unit comprises a CCD and a CCD driver.

7. An image forming apparatus for reading a document image to form an image corresponding thereto, comprising:
a photoelectric conversion unit which converts an optical image on a document into an electric image signal;
an image processing unit which processes the image signal outputted from the photoelectric conversion unit, and provides the image data;
an image forming unit which forms an image corresponding to the image data provided from the image processing unit onto a paper;
a power source unit which supplies power to respective units including the photoelectric conversion unit, the image processing unit, and the image forming unit of the image forming apparatus; and
a power supply control unit which controls power supply from the power source unit to the photoelectric conversion unit.

8. An image forming apparatus according to claim 7, wherein the power supply control unit stops power supply to the photoelectric conversion unit when the image forming apparatus is in a power saving mode.

9. An image forming apparatus according to claim 8, wherein the power saving mode is set in a case where the image forming apparatus is not used for a predetermined time.

10. An image forming apparatus according to claim 8, wherein the power saving mode is set in accordance with turning a power saving button on.

11. An image forming apparatus according to claim 6, wherein the image forming unit includes a fixing unit in which a toner image formed on a paper sheet is fixed on the paper, and a second power supply control unit which selectively controls power supply to the fixing unit, and the first and second power supply control units respectively stop power supply to the photoelectric conversion unit and the fixing unit when the image forming apparatus is in the power saving mode.

12. An image forming apparatus for reading a document image to form an image corresponding thereto, comprising:
a CCD (Charge Coupled Device) which converts an optical image on a document into an electric image signal;
an image processing circuit which processes the image signal outputted from the CCD, and provides the image data;
a printer unit which forms an image corresponding to the image data provided from the image processing circuit onto a paper;
a power source unit which supplies power to respective units including the CCD, the image processing circuit, and the printer unit of the image forming apparatus;
a switch which switches power supply from the power source unit to the CCD; and
a CPU (Central processing Unit) which controls power supply from the power source unit to the CCD by using the switch.
